(19) United States
(12) Patent Application Publication
(10) Pub. No.: US 2013/0271843 A1
(43) Pub. Date: Oct. 17, 2013

(54) PROCESS FOR PRODUCING A REFLECTION-REDUCING INTERFERENCE LAYER SYSTEM AS WELL AS REFLECTION-REDUCING INTERFERENCE LAYER SYSTEM

(71) Applicant: Carl Zeiss Jena GmbH, Jena (DE)

(72) Inventors: Stephane Bruynooghe, Aalen (DE); Thomas Koch, Huettlingen (DE); Alexandre Gatto, Jena (DE); Michael Helgert, Jena (DE)

(21) Appl. No.: 13/860,231

(22) Filed: Apr. 10, 2013

(30) Foreign Application Priority Data
Apr. 11, 2012 (DE) 102012205869.9

(51) Int. Cl. G02B 1/11

(52) U.S. Cl. CPC G02B 1/11
USPC 359/601; 427/162; 216/24

(57) ABSTRACT

A process for producing a reflection-reducing interference layer system is provided, in which a stack of layers is formed by applying to a surface of a substrate several layers which have alternately a high refractive index and a low refractive index, and a nanoporous final layer is applied to the stack of layers by vapour deposition of the material of the final layer at an oblique angle relative to the normal of the top layer of the stack of layers such that the refractive index of the final layer is lower than the refractive index of the top layer of the stack of layers.

### PRIORITY

This application claims priority to German Patent Application No. 102012205869.9, filed on Apr. 11, 2012, which is hereby incorporated herein by reference in its entirety.

### FIELD

The present invention relates to a process for producing a reflection-reducing interference layer system as well as a reflection-reducing interference layer system.

### BACKGROUND

It is known, for the anti-reflection coating of optical elements, to apply a reflection-reducing interference layer system to the surfaces of the element. However, there is the continuing need to further improve the anti-reflection properties of the interference layer system. In particular if an anti-reflection coating is desired over a broad wavelength range, improvements in the anti-reflection properties are possible with difficulty for example by increasing the number of layers. Besides, an increase in the number of the layers leads, in undesired manner, to higher costs.

### SUMMARY

Starting from here, an object of certain embodiments of the invention is to provide a process for producing a reflection-reducing interference layer system with which an improved reflection-reducing interference layer system can be produced. Furthermore, an improved reflection-reducing interference layer system is provided.

The object is achieved in certain embodiments by a process for producing a reflection-reducing interference layer system, in which a stack of layers is formed by applying to a surface of a substrate several layers which have alternately a high refractive index and a low refractive index, and in which a nanoporous final layer is applied to the stack of layers by vapour deposition of the material of the final layer at an oblique angle relative to the normal of the top layer of the stack of layers such that the refractive index of the final layer is lower than the refractive index of the top layer of the stack of layers. The anti-reflection properties are clearly improved by the provision of such a final layer.

The stated refractive indices are to be present in the wavelength range for which the interference layer system according to the invention is designed.

By a nanoporous final layer is meant in particular that the nanoporous final layer has pores the extent of which is so small that it cannot be resolved by the incident radiation for which the interference layer system is designed. Thus, for the incident radiation, the nanoporous final layer has an effective refractive index which is lower than the refractive index of the material for producing the nanoporous final layer, as there is usually air in the pores, the refractive index of which is always lower than that of the material of the final layer.

An example of such a vapour deposition at an oblique angle is the so-called GLAD process (GLancing Angle Deposition), which is known to a person skilled in the art. In particular, reference is made in this regard by way of example to Y.-P. Zhao et al., “Designing Nanostructures by Glancing Angle Deposition”, Proceedings of SPIE Vol. 5219 Nanotubes and Nanowires, pages 59-73. The vapour deposition processes described there are hereby incorporated in full and can be used for the application of the nanoporous final layer.

In the process according to certain embodiments of the invention the material of the final layer can be vapour-deposited at an oblique angle of at least 60° and smaller than 85°.

Furthermore, the stack of layers can either be moved or not be moved during the vapour deposition of the material of the final layer.

In the process according to certain embodiments of the invention the layers of the stack of layers and the layer of the final layer can in both cases be formed from non-organic materials. In particular, the final layer can be formed with a layer thickness in the range of 30-200 nm, preferably of 50-150 nm. Furthermore, the final layer can be formed with an effective refractive index of less than 1.3 (for the wavelength range for which the reflection-reducing interference layer system is designed). The effective refractive index can also be lower than 1.2 or lower than 1.1. A fluoride layer (for example MgF₂) or an oxide layer (e.g. SiO₂) can be used as material for the final layer.

The vapour deposition can be carried out at room temperature or at a higher temperature from e.g. the range of 50° C.-300° C., wherein e.g. 150° C. leads to good results with MgF₂.

The substrate can be formed in particular as a transparent substrate. Furthermore, the substrate can be an optical element, such as e.g. a lens. It is also possible for the surface to which the stack of layers is applied to be flat or to be formed curved.

Advantageously, the process according to the invention can be carried out in one and the same coating unit in which the layers of the stack of layers are also applied (e.g. under vacuum). For this, the holder in the coating unit can e.g. be formed such that it can be tilted. As the coating in such coating units is normally carried out under vacuum, an additional inward and outward transfer is thus not necessary for the formation of the nanoporous final layer.

In the process according to certain embodiments of the invention for producing a reflection-reducing interference layer system, the refractive index of the nanoporous final layer can in particular be lower than the lowest refractive index of the layers of the stack of layers.

The object in certain embodiments is furthermore achieved by a reflection-reducing interference layer system with a stack of layers with several layers which have alternately a high refractive index and a low refractive index, and a nanoporous final layer, applied to the top layer of the stack of layers, the refractive index of which is lower than the refractive index of the top layer of the stack of layers and which is formed by vapour deposition of the material of the final layer at an oblique angle relative to the normal of the top layer of the stack of layers.

Excellent anti-reflection properties can be provided with a reflection-reducing interference layer system.

In the reflection-reducing interference layer system, the layers of the stack of layers and the layer of the final layer can in both cases be formed from non-organic materials. In addition, the final layer can be formed with a layer thickness in the range of 50-150 nm. The final layer can have an effective refractive index of less than 1.3, in particular less than 1.2 and preferably less than 1.1.

In addition, in the reflection-reducing interference layer system according to certain embodiments of the invention the refractive index of the nanoporous final layer can be lower than the lowest refractive index of the layers of the stack of layers.

Furthermore, an optical element with a surface is provided, wherein a reflection-reducing interference layer system according to the invention is applied to the surface.

The applied reflection-reducing interference layer system can have the described developments.

In particular, the process according to certain embodiments of the invention for producing a reflection-reducing interference layer system can be developed such that the reflection-reducing interference layer system according to the invention (including its developments) can be produced. The reflection-reducing interference layer system according to certain embodiments of the invention can also have features which are described in conjunction with the production process according to the invention.

In addition, a process for producing a reflection-reducing interference layer system is provided in which a stack of layers is formed by applying several layers to a surface of a substrate which have alternately a high refractive index and a low refractive index, and in which a final layer of the stack of layers is produced by forming a stochastic surface relief structure by means of dry etching with self-masking such that the refractive index of the final layer is lower than the refractive index of the top layer of the stack of layers (preferably lower than the lowest refractive index of the layers of the stack of layers).

In this process, the final layer can be formed with a refractive index of less than 1.3 (in particular for the wavelength range for which the reflection-reducing interference layer system is designed) and/or with a thickness in the range of from 30 to 200 nm.

In addition, the layers of non-organic materials can be applied by a vacuum coating process.

In addition, the substrate can be an optical element, such as e.g. a lens, wherein the surface to which the stack of layers is applied can be formed flat or curved.

This process for producing a reflection-reducing interference layer system can be developed in the same way as the already described process for producing a reflection-reducing interference layer system in which the nanoporous final layer is formed by vapour deposition of the material at an oblique angle.

By the stack of layers with several layers which have alternately a high refractive index and a low refractive index is meant here in particular that a high refractive index layer has a higher refractive index than the directly adjacent low refractive index layer. The high refractive index and low refractive index layers can in each case be layers of the same material. However, it is also possible for different low refractive index layers to be formed from different materials and/or for different high refractive index layers to be formed from different materials.

For example MgF₂ with a refractive index of 1.38, SiO₂ with a refractive index of 1.46 and Al₂O₃ with a refractive index of 1.67 can be used as material for a low refractive index layer. For example TiO₂ with a refractive index of 2.3 or substance H1 (coating material from Merck) with a refractive index of 2.1 can be used as material for a high refractive index layer. The stated refractive indices refer to the visible spectral range.

It is understood that the features mentioned above and those yet to be explained below can be used, not only in the stated combinations, but also in other combinations or alone, without departing from the scope of the present invention.

### BRIEF DESCRIPTION OF THE DRAWINGS

The invention is explained in further detail below by way of example with reference to the attached drawings which also disclose features essential to the invention. There are shown in:

FIG. 1 is a schematic representation of a reflection-reducing interference layer system according to certain embodiments of the invention;

FIG. 2 is a schematic representation to illustrate the process for producing a reflection-reducing interference layer system;

FIG. 3 is a representation of the reflectance of the reflection-reducing interference layer system according to the invention according to FIG. 1 compared with a conventional reflection-reducing interference layer system;

FIG. 4 is a representation of the reflectance of a further reflection-reducing interference layer system according to certain embodiments of the invention compared with a conventional reflection-reducing interference layer system;

FIG. 5 is a representation of the reflectance of a further reflection-reducing interference layer system according to certain embodiments of the invention compared with a conventional reflection-reducing interference layer system;

FIG. 6 is a representation of the reflectance of a further reflection-reducing interference layer system according to certain embodiments of the invention compared with a conventional reflection-reducing interference layer system;

FIG. 7 is a representation of the reflectance of a further reflection-reducing interference layer system according to certain embodiments of the invention compared with a conventional reflection-reducing interference layer system; and

FIG. 8 is a representation of the reflectance of a further reflection-reducing interference layer system according to certain embodiments of the invention compared with a conventional reflection-reducing interference layer system.

### DETAILED DESCRIPTION

The present invention can be explained with reference to the following example embodiments. However, these example embodiments are not intended to limit the present invention to any specific examples, embodiments, environments, applications or implementations described in these embodiments. Therefore, description of these embodiments is only for purpose of illustration rather than to limit the present invention.

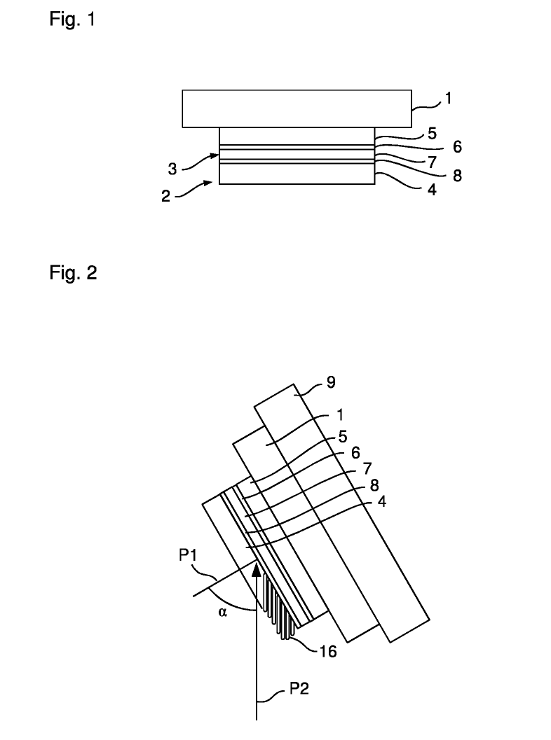

FIG. 1 shows a substrate 1 with a reflection-reducing interference layer system 2 according to certain embodiments of the invention which comprises a stack of layers 3 and a nanoporous final layer 4 formed thereon. The substrate 1 is transparent for radiation of a predetermined wavelength range (e.g. 400-700 nm). Thus, the substrate can be formed e.g. from plastic or glass. In the example described here, it is glass (e.g. BK7). The substrate 1 is preferably an optical element (such as e.g. a lens) which is to be given an anti-reflection coating.

The stack of layers 3 has four layers 5, 6, 7, 8 which have alternately a high refractive index and a low refractive index. The layers 5 and 7 in each case are an Al₂O₃ layer (low refractive index) and the layers 6 and 8 are an H1 layer (H1 is a coating material from Merck), wherein the H1 layers are the high refractive index layers. The layer thicknesses of the layers 5 to 8 are 91.1 nm, 24.1 nm, 52.4 nm and 21.2 nm.

The nanoporous final layer 4 is formed on this stack of layers, and thus on the fourth layer 8. The nanoporous final layer has pores the extent of which is so small that it cannot be resolved by the incident radiation for which the interference layer system 2 is designed. Thus, the pores can in particular have a maximum extent of less than a few 10 s of nm. For the incident radiation, therefore, the nanoporous final layer 4 has an effective refractive index which is lower than the refractive index of the material for producing the nanoporous final layer 4, as there is usually air in the pores, the refractive index of which is always lower than that of the material for the final layer 4.

The nanoporous final layer 4 here is formed from MgF₂ and has a thickness of 107.3 nm, wherein the nanoporous final layer 4 was formed by vapour deposition of MgF₂ at an oblique angle relative to the normal P1 of the fourth layer 8. This is represented schematically in FIG. 2. The substrate 1 with the stack of layers 3 is secured to a carrier 9 which is inclined relative to the direction of vapour deposition (indicated by arrow P2) of the material for the nanoporous final layer 4 such that the angle of vapour deposition a is approx. 60°. The angle of vapour deposition a can be in the range of at least 55° and less than 75°.

Columnar structures 16 which are inclined relative to the normal of the fourth layer 8 because of the oblique angle of vapour deposition are thereby formed, as indicated schematically in FIG. 2. The representation in FIGS. 1 and 2 is not to scale, in order to be able to better illustrate the invention.

Such a vapour deposition at an oblique angle is e.g. the so-called GLAD process (GLancing Angle Deposition).

If, as in the example described here, the stack of layers 3 is not changed relative to the direction of vapour deposition P2 during the vapour deposition of the material for the nanoporous final layer 4 and the stack of layers 3 is also not moved, the nanoporous final layer 4 has the described columnar nanostructure. In this case, the nanoporous final layer 4 can also be called a columnar thin layer. Such a columnar thin layer is represented schematically in FIG. 2.

Naturally, it is also possible to rotate the stack of layers 3 during the vapour deposition of the material for the nanoporous final layer 4 and/or to move it translationally, with the result that the columnar nanostructures do not extend in a straight line, but can have other shapes, such as e.g. a helical structure, columns which extend in a zigzag shape, square spirals, etc.

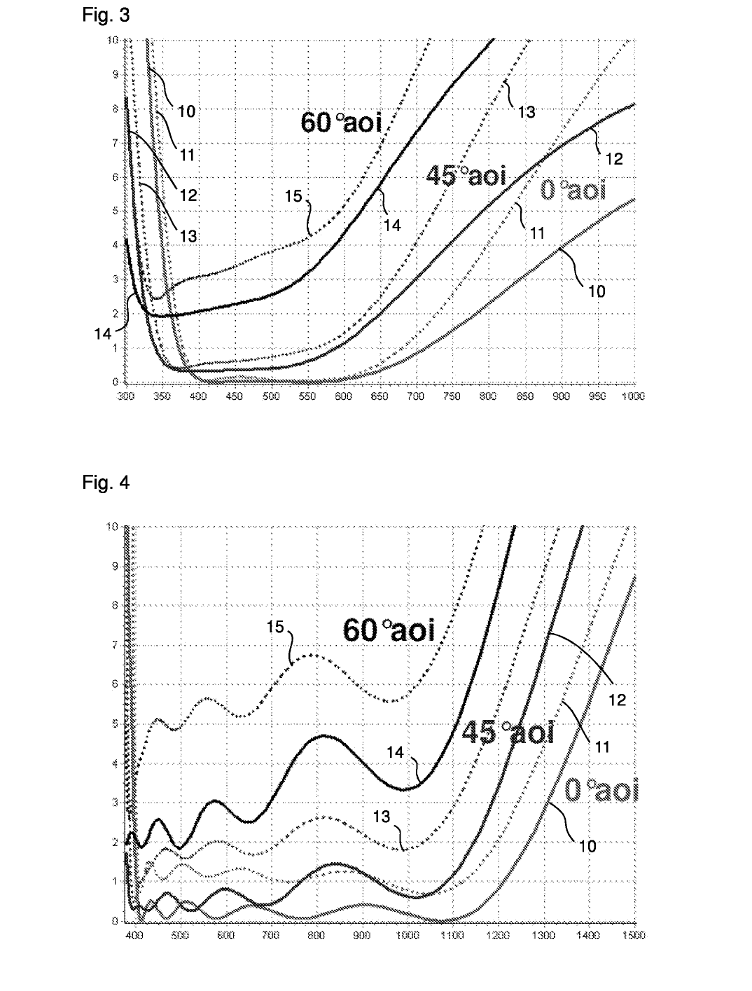

In FIG. 3, the reflectance is represented as a percentage relative to the wavelength of the incident unpolarized radiation for three different angles of incidence (60° aoi=angle of incidence of 60°; 45° aoi=angle of incidence of 45° and 0° aoi=angle of incidence of 0°), wherein the reflectance is plotted on the y-axis and the wavelength in nm is plotted on the x-axis. The curve 10 shows the reflectance of the reflection-reducing interference layer system 2 according to FIG. 1 in % at an angle of incidence of 0° compared with the reflectance of a conventional reflection-reducing interference layer system, which is represented as curve 11. The conventional interference layer system has the same sequence of layers as the layer system according to FIG. 1, with the difference that the final layer in the conventional interference layer system is formed not as a nanoporous final layer, but as a normal MgF₂ layer which has e.g. a refractive index of more than 1.35 in the visible wavelength range. As shown from a comparison of the curves 10 and 11 (the reference numbers 10 and 11 are drawn in several times in order to make it clear which line belongs to which curve), the interference layer system 2 according to the invention has a lower, and thus an improved, reflectance.

The curve 12 shows the reflectance of the reflection-reducing interference layer system 2 according to FIG. 1 in % for an angle of incidence of 45° and the curve 14 shows the reflectance of the reflection-reducing interference layer system according to FIG. 1 in % for an angle of incidence of 60°. The curves 13 and 15 show, in the same way as the curve 11, the reflectance of a conventional reflection-reducing interference layer system, wherein the curve 13 shows it for an angle of incidence of 45° and the curve 15 for an angle of incidence of 60°.

Thus, excellent anti-reflection properties are achieved with the reflection-reducing interference layer system 2 according to the invention even at high angles of incidence of the light.

In FIG. 4, in the same way as in FIG. 3, the reflectance is shown as a function of the wavelength of the incident unpolarized light for an interference layer system according to the invention (curves 10, 12 and 14) for angles of incidence of 0°, 45° and 60° compared with a corresponding conventional interference layer system (curves 11, 13 and 15). The structure of the interference layer system according to the invention is given in the following Table 1. It can be seen from this that the stack of layers 3 is formed with nine layers on the substrate 1 and the nanoporous cover layer is formed on this as a tenth layer.

TABLE 1

| | Layer material | Layer thickness |
|---|---|---|
| Layer no. | Substrate 1 | (nm) |
| 1 | TiO₂ | 11.2 |
| 2 | SiO₂ | 45.9 |
| 3 | TiO₂ | 28.2 |
| 4 | SiO₂ | 19.1 |
| 5 | TiO₂ | 125.9 |
| 6 | SiO₂ | 14.1 |
| 7 | TiO₂ | 23.3 |
| 8 | SiO₂ | 44.5 |
| 9 | TiO₂ | 11.1 |
| 10 | MgF₂ | 124.4 |

The reflectance according to curves 11, 13 and 15 corresponds to that of a conventional interference layer system for the angles of incidence 0°, 45° and 60°, which has ten layers in the same way as the interference layer system according to the invention, wherein however the last layer is formed not as a nanoporous final layer, but as a normal MgF₂ thin layer.

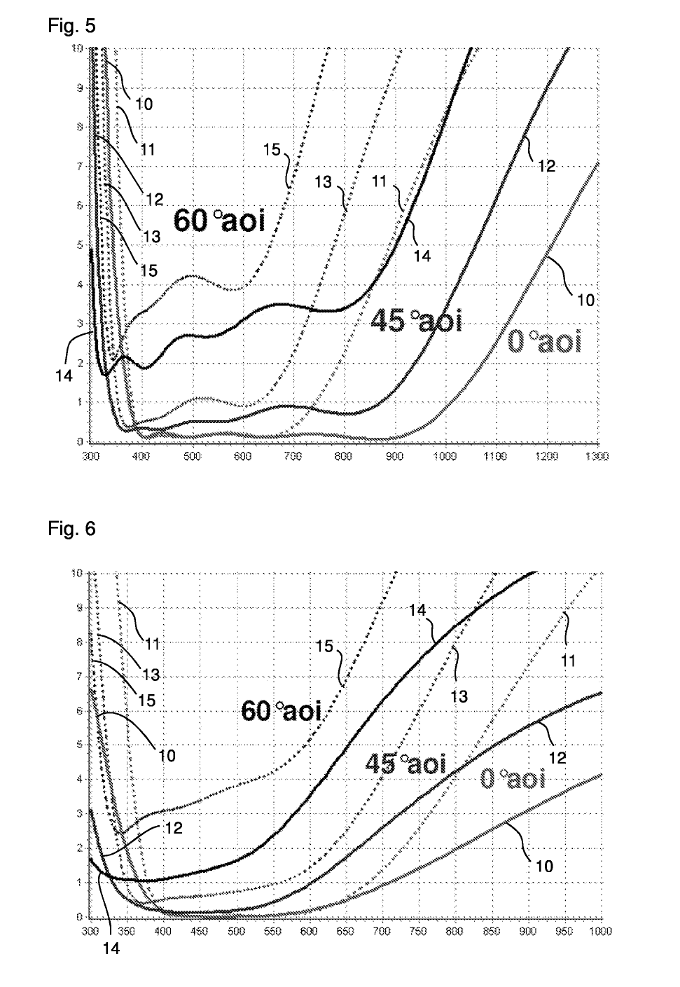

In FIG. 5 the reflectance for a further embodiment of the interference layer system 2 according to the invention is shown, in the same way as in FIG. 2, compared with a conventional interference layer system in which the final layer is not a nanoporous MgF₂ layer, but only a conventional MgF₂ layer. The structure of the interference layer system according to this embodiment is given in the following table 2:

TABLE 2

| | Layer material | Layer thickness |
|---|---|---|
| Layer no. | Substrate 1 | (nm) |
| 1 | Al₂o₃ | 79.3 |
| 2 | H1 | 20.6 |
| 3 | MgF₂ | 14.7 |
| 4 | H1 | 138.1 |
| 5 | MgF₂ | 28.4 |
| 6 | H1 | 22.4 |
| 7 | MgF₂ | 116.2 |

In FIG. 6 the reflectance for an interference layer system according to the invention is represented in the same way as in FIG. 3. The structure of the interference layer system corresponds to the structure according to FIG. 1, wherein however the final layer 4 is not formed by oblique vapour deposition, but has a stochastic surface relief structure which is produced by dry etching with self-masking. By self-masking is meant here the process in which atoms and/or molecules attach to the surface and/or form bonds which, like a statistically distributed etch masking, provide protection against material abrasion. Its masking property is due to a lower etch rate compared with that of the material of the layer. Because of the irregular arrangement, a material abrasion of locally different height, and thus the desired surface structuring, then results. Such a self-masking occurs e.g. during reactive dry etching in fluorine-containing plasmas.

The layer thicknesses of the first to the fourth layer in the example described here are 93.8 nm, 15.6 nm, 71.5 nm and 5.0 nm. The final layer 4 is an SiO₂ layer with a thickness of 163.8 nm, wherein the described surface relief structure is present. Thus, in this case too, the final layer has an effective refractive index which is lower than the refractive index of the material from which the final layer is formed, as the structuring only has those dimensions which cannot resolve the radiation for which the interference layer system 2 according to the invention is designed.

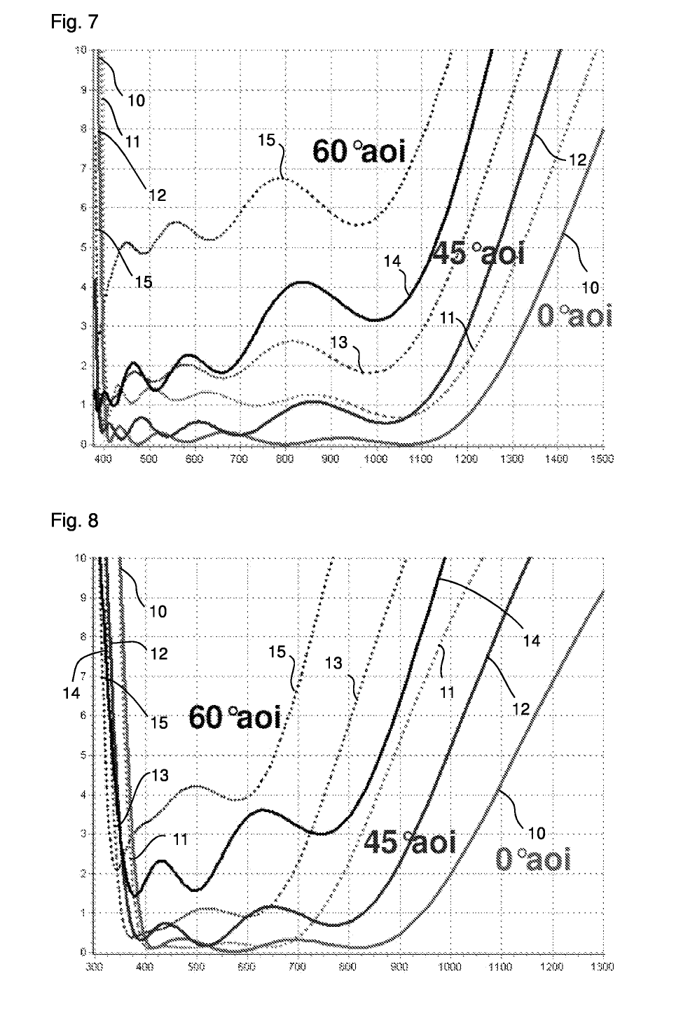

In FIG. 7 the reflectance for a further embodiment of the interference layer system 2 according to the invention is represented in the same way as in FIG. 4, wherein the interference layer system according to FIG. 7 has a very similar sequence of layers to the interference layer system according to FIG. 2, as can be seen from the following table 3. In addition, the final SiO₂ layer is formed, in the same way as in the interference layer system according to the invention according to FIG. 6, with a stochastic surface relief structure.

TABLE 3

| | Layer material | Layer thickness |
|---|---|---|
| Layer no. | Substrate 1 | (nm) |
| 1 | TiO₂ | 11.4 |
| 2 | SiO₂ | 45.9 |
| 3 | TiO₂ | 29.4 |
| 4 | SiO₂ | 18.9 |
| 5 | TiO₂ | 139.5 |
| 6 | SiO₂ | 24.0 |
| 7 | TiO₂ | 18.8 |
| 8 | SiO₂ | 71.4 |
| 9 | SiO₂ | 163.8 |

In FIG. 8 the reflectance is shown in the same way as in FIG. 5 for a similar interference layer system according to the invention, wherein the interference layer system according to FIG. 8 has the same sequence of layers as the interference layer system according to FIG. 5, but the layer thicknesses vary and the final SiO₂ layer is in turn formed with a stochastic surface relief structure. The layer thicknesses and the sequence of layers are given in the following table 4:

TABLE 4

| | Layer material | Layer thickness |
|---|---|---|
| Layer no. | Substrate 1 | (nm) |
| 1 | Al₂O₃ | 42.0 |
| 2 | H1 | 19.6 |
| 3 | MgF₂ | 18.8 |
| 4 | H1 | 145.6 |
| 5 | MgF₂ | 33.3 |
| 6 | H1 | 14.8 |
| 7 | SiO₂ | 163.8 |

As can be seen from all of the FIGS. 3 to 8, the embodiments of the interference layer system according to the invention have excellent anti-reflection properties over a large range of angles of incidence (in particular even at high angles of incidence).

The reflection-reducing interference layer system 2 according to the invention is of advantage in particular for a very broadband anti-reflection coating, as precisely in the range of g≧2 (g is the ratio of the highest wavelength to the lowest wavelength of the spectral range for which the interference layer system is designed) clear improvements in the anti-reflection coating can be achieved. In particular with a g value of up to 3, clear improvements can be achieved.

The interference layer system according to the invention can, as previously described, not only be applied to a flat surface of the substrate 1. The substrate 1 can be e.g. a lens with a curved surface to which the reflection-reducing interference layer system 2 is then applied. As material for the substrate 1 there can be used e.g. BK7.

The layers of the interference layer system according to certain embodiments of the invention are preferably inorganic layers or inorganic mixed media.

The provision of the low refractive index nanoporous final layer 4 leads, according to the invention, to a significant improvement of the anti-reflection effect. In particular, improvements in addition to the already described broader spectral range can be achieved by an improved angle acceptance. Even with a non-perpendicular incidence of the radiation, the anti-reflection effect is improved compared with conventional anti-reflection coatings.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A process for producing a reflection-reducing interference layer system, comprising:
forming a stack of layers by applying to a surface of a substrate several layers which have alternately a high refractive index and a low refractive index; and
applying a nanoporous final layer to the stack of layers by vapour deposition of the material of the final layer at an oblique angle relative to the normal of the top layer of the stack of layers such that the refractive index of the final layer is lower than the refractive index of the top layer of the stack of layers.

2. The process according to claim 1, wherein the material of the final layer is vapour-deposited at an oblique angle of more than or equal to 60°.

3. The process according to claim 1, wherein the stack of layers is not moved during the vapour deposition of the material of the final layer.

4. The process according to claim 1, wherein the stack of layers is moved during the vapour deposition of the material of the final layer.

5. The process according to claim 1, wherein the layers of the stack of layers and the layer of the final layer are in both cases formed from non-organic materials.

6. The process according to claim 1, wherein the final layer is formed with a layer thickness in the range of 30-200 nm.

7. The process according to claim 1, wherein the final layer is formed with an effective refractive index of less than 1.3.

8. The process according to claim 1, wherein the final layer comprises one of a fluoride layer or an oxide layer material.

9. The process according to claim 1, wherein a glass substrate is used as the substrate.

10. The process according to claim 1, wherein an optical element is used as the substrate.

11. A reflection-reducing interference layer system, comprising:
a stack of layers including several layers which have alternately a high refractive index and a low refractive index; and
a nanoporous final layer, disposed on the top layer of the stack of layers, the refractive index of which is lower than the refractive index of the top layer of the stack of layers and which is formed by vapour deposition of the material of the final layer at an oblique angle relative to the normal of the top layer of the stack of layers.

12. An optical element including a surface, wherein a reflection-reducing interference layer system according to claim 11 is applied to the surface.

13. A process for producing a reflection-reducing interference layer system, comprising:
forming a stack of layers by applying to a surface of a substrate several layers which have alternately a high refractive index and a low refractive index; and
producing a final layer, having a nanostructure, of the stack of layers by forming a stochastic surface relief structure by means of dry etching with self-masking such that the refractive index of the final layer is lower than the refractive index of the top layer of the stack of layers.

14. A process according to claim 13, wherein the final layer is formed with an effective refractive index of less than 1.3.

15. A process according to claim 13, wherein the final layer is formed with a layer thickness in the range of 30-200 nm.

16. A process according to claim 13, wherein the layers of non-organic materials are applied by a vacuum coating process.

17. A process according to claim 13, wherein a glass substrate is used as substrate.

18. A process according to claim 13, wherein an optical element is used as substrate.
